(19) United States
(12) Patent Application Publication
(10) Pub. No.: US 2008/0253611 A1
(43) Pub. Date: Oct. 16, 2008

(54) Analyst cueing in guided data extraction

(76) Inventors: Levi Kennedy, Cary, NC (US); Paul Robert Runkle, Chapel Hill, NC (US); Lawrence Carin, Durham, NC (US); Trampas Stern, Raleish, NC (US)

Correspondence Address: John L. Sotomayor, 106 Spring Needle Ct., Cary, NC, 27513, US

(21) Appl. No.: 12/080,025

(22) Filed: Mar. 31, 2008

Related U.S. Application Data
(60) Provisional application No. 60/907,603, filed on Apr. 11, 2007.

(51) Int. Cl. G06K 9/00

(52) U.S. Cl. 382/103

(57) ABSTRACT

The Analyst Cueing method addresses the issues of locating desired targets of interest from among very large datasets in a timely and efficient manner. The combination of computer aided methods for classifying targets and cueing a prioritized list for an analyst produces a robust system for generalized human-guided data mining. Incorporating analyst feedback adaptively trains the computerized portion of the system in the identification and labeling of targets and regions of interest. This system dramatically improves analyst efficiency and effectiveness in processing data captured from a wide range of deployed sensor types.

### CROSS REFERENCE TO RELATED DOCUMENTS

This application claims priority benefit of U.S. provisional patent application No. 60/907,603, filed Apr. 11, 2007 which is hereby incorporated by reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND OF THE INVENTION

Change detection out in the field for the identification of anomalies in areas of interest is of primary importance in the gathering of information vital to the discovery of changing conditions in the field of view. This type of discovery can presage the ability to move resources into the area to deal with the changing conditions. This type of data-intensive activity is extremely time-intensive and requires highly trained personnel for the greatest effectiveness. Instituting a human-machine interaction for change detection in extremely dense sensor datasets may provide for much greater accuracy, greater efficiency and improved definitions for targets of interest within the dataset.

### BRIEF DESCRIPTION OF THE DRAWINGS

The above and other objects, features and advantages of the present invention will become more apparent in light of the following detailed description of exemplary embodiments taken in conjunction with the attached drawings, in which:

FIG. 1: provides a system block diagram of processing relationships consistent with certain embodiments of the invention.

FIG. 2: provides a view of Active Learning with an analyst-in-the-loop consistent with certain embodiments of the invention.

FIG. 3: is a view of an analyst-in-the-loop target probability consistent with certain embodiments of the invention.

FIG. 4: provides a view of an accuracy comparison for two analysts consistent with certain embodiments of the invention.

FIG. 5: is a view of analyst results efficiency consistent with certain embodiments of the invention.

### DESCRIPTION OF THE INVENTION

The pages that follow describe experimental work, presentations and progress reports that disclose currently preferred embodiments consistent with the above-entitled invention. All of these documents form a part of this disclosure and are fully incorporated by reference. This description incorporates many details and specifications that are not intended to limit the scope of protection of any utility patent application which might be filed in the future based upon this provisional application. Rather, it is intended to describe an illustrative example with specific requirements associated with that example. The description that follows should, therefore, only be considered as exemplary of the many possible embodiments and broad scope of the present invention. Those skilled in the art will appreciate the many advantages and variations possible on consideration of the following description.

Thus, the reader should understand that the present document, while describing commercial embodiments, should not be considered limiting since many variations of the inventions disclosed herein will become evident in light of this discussion. While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described.

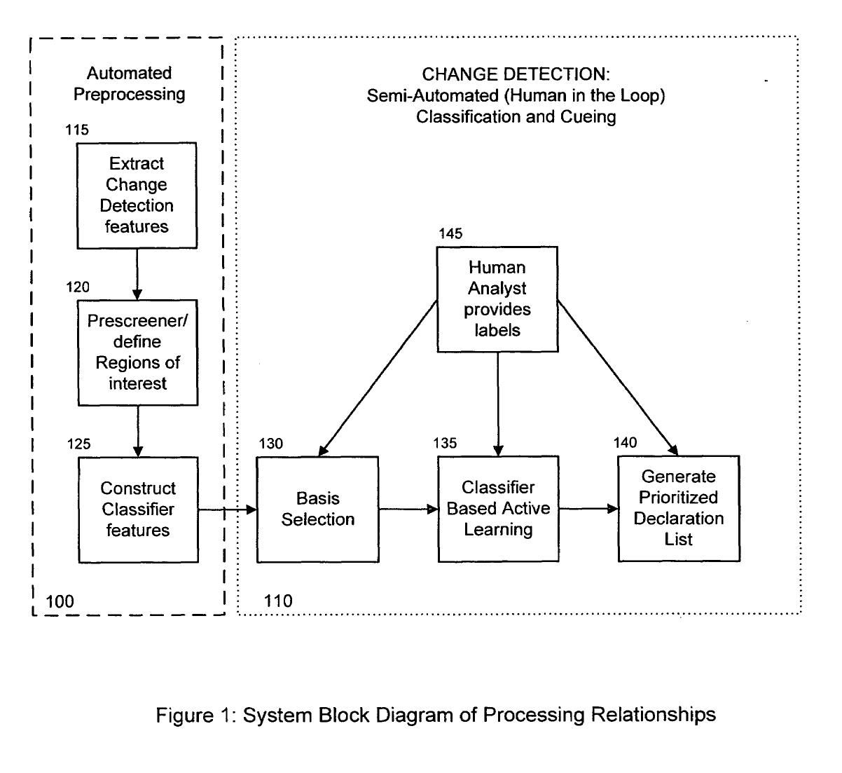

Turning to FIG. 1, consistent with certain embodiments of the invention the system consists of two major functions, Automated Preprocessing 100 of the received sensor data and Change Detection for identification and classification of areas of interest within the sensor data. The Automated Preprocessing begins by extracting and loading Change Detection features from the server storage media 115. These features provide the foundation upon which the automated processes rely in processing the incoming sensor data for areas of interest. The Prescreener module then utilizes the feature definitions to define Regions of Interest for further examination 120. A Classifier module then constructs a list of classified features as those areas that require further analysis and/or classification 125 and forwards this data to the Change Detection process.

To provide greater efficiency in the detection of pre-defined targets to be located within captured sensor data, a Change Detection (CD) 110 software process and tool is provided. The CD 110 uses a hierarchical registration procedure to align captured sensor data and highlight areas where any one of a set of pre-defined targets may have been emplaced. The CD 110 uses identified disturbances to the surrounding environment as threshold events to capture areas that should be highlighted and presented as cues to an Analyst-in-the-loop. The Analyst may then use the cues, presented as a prioritized list, to achieve much greater efficiencies in the identification of any pre-defined targets embedded within the captured sensor data set 145.

The identification of pre-defined targets within a set of data collected from a sensor array may be accomplished with any sensor array and within any collected data set. The CD 110 process is dependent upon the identification of those targets of interest 130 within the collected data set as defined by an expert analyst with deep knowledge of what targets are to be designated as “of interest” 145. In this manner, the CD 110 process utilizes the expert analyst knowledge of designated targets as the starting basis for training the CD 110 process in recognition of targets within a collected data set 135.

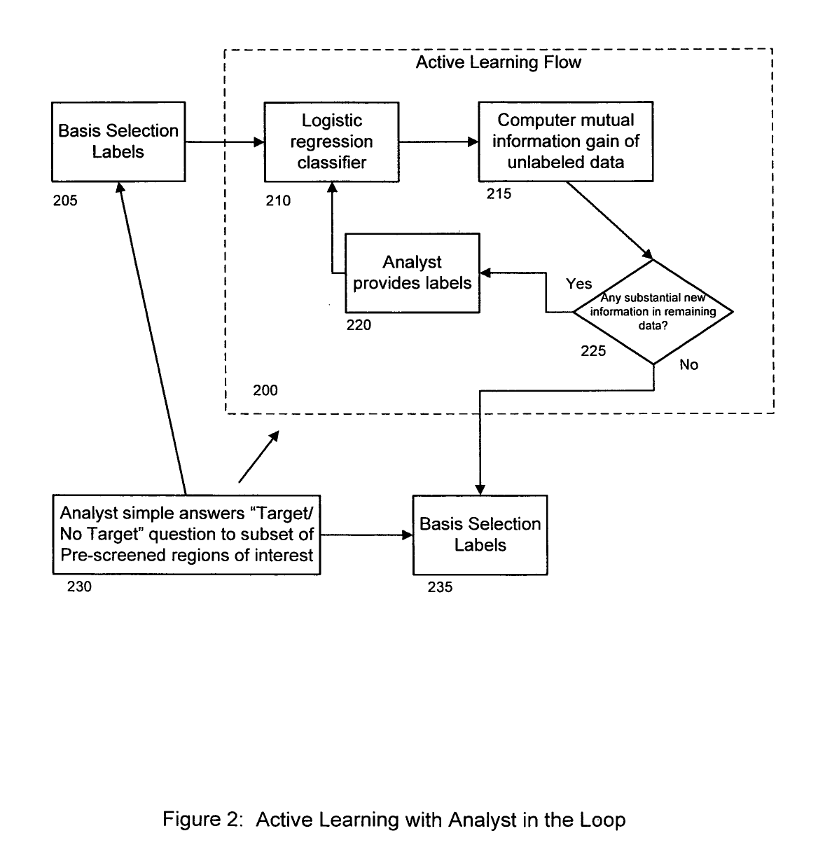

Turning to FIG. 2, consistent with certain embodiments of the invention the Active Learning Flow 200 is the module that utilizes the training and experience of the Analyst-in-the-loop to increase the basis level of region of interest recognition, identification and classification. Having an initial database of targets defined and optimized by an expert analyst 140 allows all analysts to take advantage of an expert's work. In this manner, further target definition and learning is emplaced within the target database as further optimization of the defined target data 140. This process also mitigates and partially bypasses the analyst learning curve for target identification. Each analyst begins with an expert's knowledge of targets that are to be identified and continues to optimize the database as new targets and categories of targets are recognized and defined.

The Active Learning Flow 200 module receives the current Basis Selection Labels 205 as an initial identification and classification starting point. This data set is directed as input to a logistic regression classifier module 210 that provides a list of all recognized and labeled targets within a region of interest as well as a list of unlabeled suspected targets that meet some or all of the classification parameters but do not fit into an established classification category. The logistic regression classifier module 210 also receives as input any new labels for unlabeled suspected targets that have been provided by the Analyst-in-the-loop 220. The system server then reconciles the newly added labels with the incoming unlabeled suspected targets in an information gain for all unlabeled data 215, and presents this data to the Analyst. In an iterative step, the Active Learning Flow module 200 compares the labeled data, unlabeled data, and classification parameters to determine what, if any, substantial new information remains in the incoming data 225. If there are newly characterized targets within the remaining data, these targets are presented to the Analyst for labeling, if there are newly characterized targets that are sufficiently within the parameters of previously defined labels or classification parameters, the Active Learning Flow 200 module labels these targets and presents them to the Analyst for concurrence. Once all new information within the remaining data has been processed and there are no further data objects that might be considered for labeling as being targets or of interest, the Basis Selection Labels 205 data tables are updated 235 to reflect the new level of data identification and understanding.

The CD 110 process can be utilized with any target that can be defined as “of interest” within any set of collected data from any deployed sensor array. In an embodiment of interest, the deployed sensor array is an array that collects visual data, from both visible light and infrared spectra. The targets of interest within this same embodiment are Improvised Explosive Devices (IEDs) and analysts have established a pre-identified set of targets based upon changes in a visual environment. Although this embodiment has been deployed and tested the invention herein described is in no way limited to just this type of sensor array, or the targets defined for this embodiment. An Analyst may use the most recent Basis Selection Labels 205 data tables to perform a simple Target/No Target analysis process 230 to provide feedback and concurrence with the most recent data tables. This step provides training for less experienced analysts and insures the quality and integrity of the labeled data within the Basis Selection Labels 205 stored data tables. Other embodiments of interest could include medical, financial, security, intelligence and process control sensor arrays with targets of interest comprising anomalous objects specific to each of these industry segments. Thus, the described invention is in no way limited to the single embodiment of interest that is further discussed herein below.

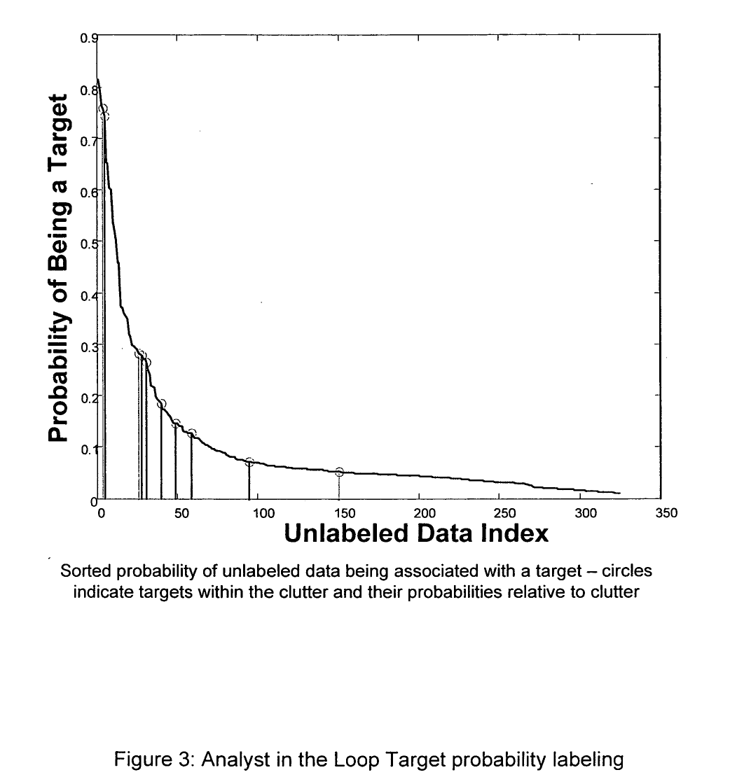

Turning to FIG. 3, consistent with certain embodiments of the invention, this diagram presents a representation of the sorted probability of unlabeled data being associated with a target. For a data set consistent with an embodiment of the invention the system has provided a list of probable labeled targets from a set of hundreds of data points that may represent clutter, along with their probabilities relative to clutter. This data is presented to an Analyst in probability order with the highest probability labeled data presented first, lowest probability labeled data presented last.

For this embodiment of interest, the CD 110 process requires visible light data (monochromatic) and infrared data (MWIR) collected for the same target area over two separate collection periods (day 1 and day 2). The data from both mono and MWIR passes requires coarse registration (within approximately 10 pixels across the images). The registration solves for differences in parameters such as sensor height and sensor angle in order to align all captured images. This coarse scale registration assures that a fine scale (pixel level) registration can be performed during feature extraction via a simple horizontal and vertical translation. The pixel level registration is accomplished by finding the local translation that produces the maximum correlation between day 1 and day 2 imagery data. The coarse level registration is required across all four data sets, mono day 1, mono day 2, MWIR day 1 and MWIR day 2. Because of the difference in resolution between the sensors, the MWIR data is up-sampled prior to the registration procedure so that all four image sets are the same resolution.

Suitable key points in all sets of imagery are identified, such as the locations represented by the key points. The key points are used in an elastic registration technique to coarsely register the images. Once the four sets of images are registered with each other, features can be extracted based on the changes between the mono day 1 and day 2 and the MWIR day 1 and day 2 captured data sets. Change detection 110 features between mono and MWIR data sets can then also be associated with each other because of the initial co-registration.

For each of the image sets (mono day 1 and day 2, and MWIR day 1 and day 2) the system applies an initial detector to identify regions of interest (ROI). The goal of defining the ROIs is to associate the extracted CD 110 features which are related to a particular physical disturbance in the collected data image. This association reduces the false alarms (features that are selected but that do not, upon subsequent view by an analyst, correspond to targets) to a manageable size and removes ambiguity between features and the objects in the collected data images.

A target detection process is applied to the imagery to extract targets by element-wise multiplying the feature plots of the between day mono and MWIR images. The resulting plot represents areas where there are day 1 to day 2 changes for both the mono and the MWIR imagery. A threshold may then be applied based upon a desired probability of target detection versus the number of false alarms. The threshold is applied to the captured image data and determines the total number of ROIs and the possibility of missing actual targets, with a threshold set to achieve a very high probability of detection of ROIs containing targets.

Once the detector process selects a set of ROIs, the original features for those ROIs are assembled into a feature vector for each ROI. A feature vector is created using the maximum mono Mean Square Error (MSE) in the ROI, the maximum MWIR MSE in the ROI, the distance of the ROI centroid from a road, the area of the ROI, the eccentricity of the ROI shape, and the orientation, relative to the axes, of the ROI shape. The last three features help exclude ROIs associated with shadow artifacts which account for a majority of false alarms.

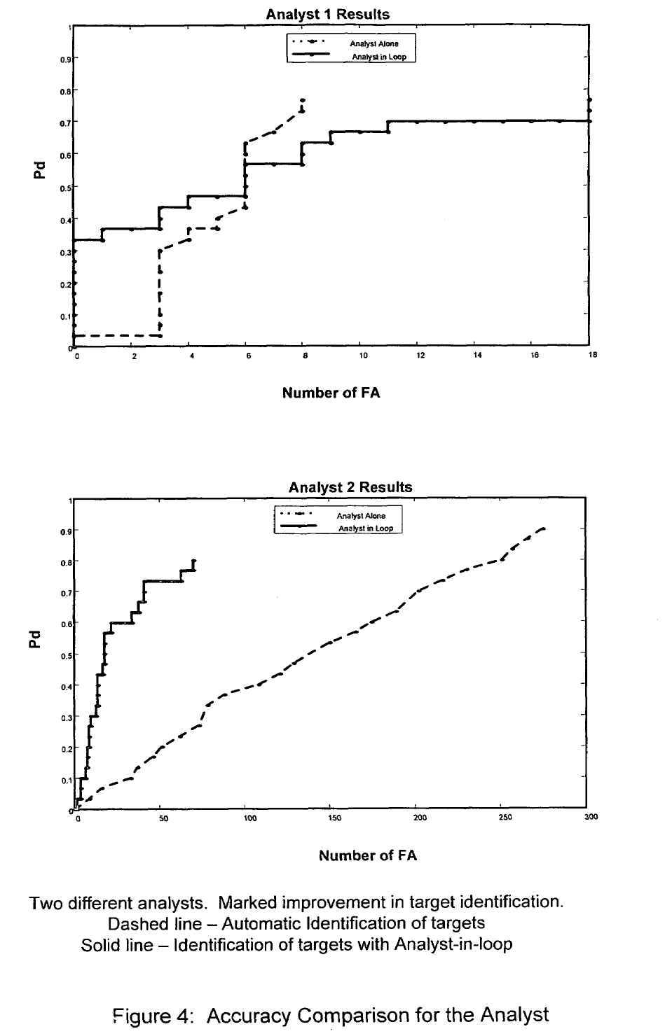

Turning to FIG. 4, the feature vectors are then prioritized based upon the probability that the ROI may contain a target of interest, based upon the learned classification for targets previously identified. This prioritized list of ROI feature vectors is then presented to analysts viewing the captured imagery. In this manner, each analyst is presented with high probability of target ROIs, minimizing the amount of time an analyst must view non-productive portions of the imagery and maximizing target identification versus false alarms. In a certain embodiment the presentation of priority classified data and the automated pre-classification of targets within regions of interest improves the accuracy of the target identification and labeling of real targets in the field. This figure illustrates an improvement in the accuracy for two different analyses. The computer server was presented with sensor data that had been pre-classified for regions of interest and then attempted to locate and label a set of real targets that were placed in known positions in the field. A second set of sensor data with targets placed in known positions was then presented to the computer server, but this time with an analyst assisting in the identification and labeling of targets. The results data is graphed as the number of targets located (Number of FA) versus the Percentage Detected (Pd) accurately. For each analyst there was a marked improvement in the accuracy of targets identified and labeled within the data sets presented.

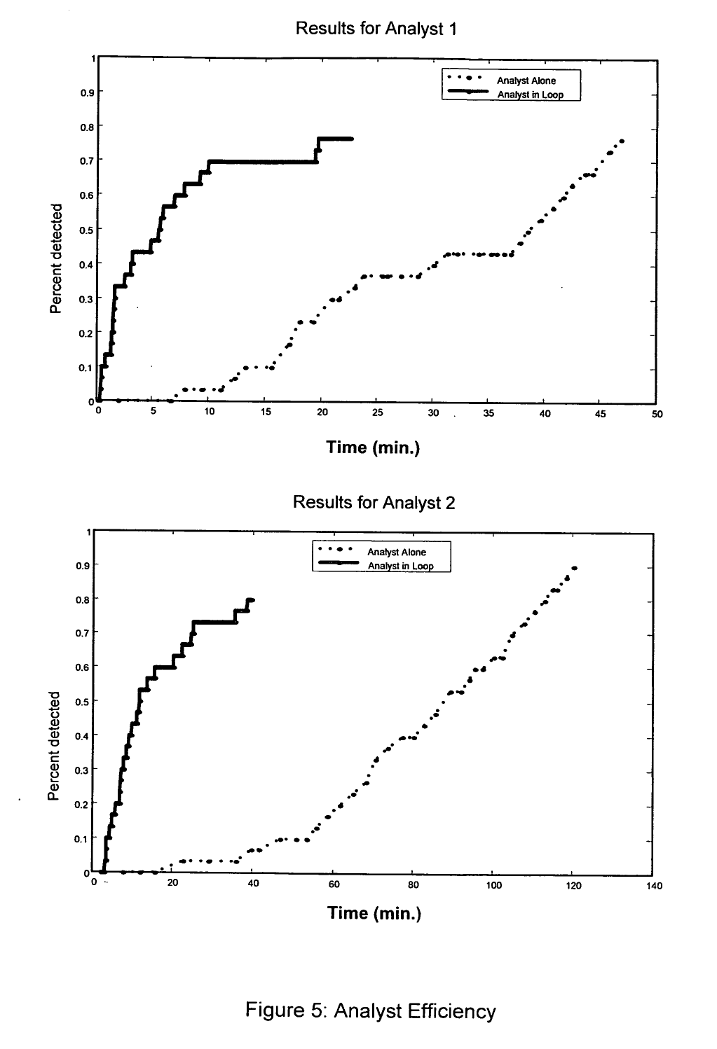

Turning to FIG. 5, active learning is an integral portion of utilizing analyst feedback to improve target and ROI identification in an iterative fashion. Not all unlabeled data are equally informative for reducing the uncertainty of the classifier weights for the feature vectors chosen. A classifier process is trained based on labels provided by an analyst for feature vectors chosen via basis selection with the active learning objective function being calculated for all remaining unlabeled data. The goal is to select the unlabeled feature vector to maximize the mutual information between the unknown label for a new feature and the classifier weights to be sought. By labeling the most informative data first, the classifier can be training with the fewest number of labeled data points. As shown in the exemplary figure, two different analysts are presented with a data set in which each analyst must locate a plurality of targets with known positions but without the assistance of the CD 110 server. Each analyst is then presented with a second data set containing known targets and tasked with locating all targets with the assistance of the CD 110 server. As shown in the exemplary figure, when operating as an Analyst-in-the-loop each analyst improved markedly in both the number of targets identified and labeled (percent detected) and the amount of time required to locate the targets that were identified and labeled. In a plurality of trials with a number of analysts this improvement is in the range of 300 to 400 percent over target identification and labeling by an analyst alone. This maximizes the training effort and reduces the cost in terms of time and data that must be collected for training.

Once the ROIs and possible target information is presented to an analyst, the analyst will view the captured imagery, scanning back and forth between day 1 and day 2 imagery. The analyst will provide feedback to the learning database in the form of reinforcement verification for targets that are positively identified, negative verification for those possible identified targets that are false alarms, and identification data for objects that are new target types. All ROIs are labeled in order of probability to provide positive verification for targets within the captured imagery data and to maximize the probability of detection per unit of analyst time.

In the disclosed embodiment, the process disclosed above prior to presenting this list to an analyst has resulted in performance improvements in the 300 to 400 percent range for test data supplied. This performance improvement can be partially ascribed to the advantage of an analyst having prioritized and pre-screened ROIs presented for labeling, thus reducing the amount of imagery each analyst must review. In addition, the prioritization of ROIs allows analysts to view the ROIs most likely to contain targets at the beginning of a review cycle when an analyst is more alert. At the same time, the disclosed method is more efficient at allowing an analyst to operate on an identified list of ROIs in significantly less time than operations performed without such a prioritized list. This results not only in the positive identification of a larger percentage of true targets in a shorter time period, but also contributes to a huge reduction in false alarms.

While certain illustrative embodiments have been described, it is evident that many alternatives, modifications, permutations and variations will become apparent to those skilled in the art in light of the description.

We claim:

1. A method for change detection of targets within regions of interest in a sensor derived data set comprising:
receiving a data set of sensor information collected in the field;
extracting features and regions of interest from within the sensor dataset;
constructing a classifier defined set of features;
building a separate data set containing identified and labeled targets;
generating a prioritization list of said identified and labeled targets;
presenting said prioritized list of identified and labeled targets to a human analyst; and
wherein the human analyst may input new labels and target identification to the prioritized list which is then incorporated into said data set containing identified and labeled targets, said data set then formatted and presented upon a display for use by the human analyst.

2. A method according to claim 1, wherein the sensors collecting data comprise an array of sensors deployed to collect samples from a defined area.

3. A method according to claim 1, further comprising:
said extraction of features and regions of interest is performed by a software module resident upon a server capable of network communications;
said software module comparing extracted features and regions of interest against a predefined set of interest criteria; and
wherein the server module provides a pre-screening function for all extracted data of interest.

4. A method according to claim 1, wherein said predefined interest criteria further comprise a defined set of features that form the basis data set of labels for all previously identified and selected targets.

5. A method according to claim 1, wherein the separate data set containing identified and labeled targets is separate from the basis data set of labels.

6. A method according to claim 1, wherein the separate data set containing identified and labeled targets includes labels generated by the server module without assistance from a human analyst.

7. A method according to claim 1, wherein said prioritized list is a combination of the basis data set of labeled targets and the separate data set containing labeled targets.

8. A method according to claim 1, wherein the human analyst provides feedback to the server module in a series of iterative steps that proceeds until all new data set information has been compared, identified, labeled and/or discarded.

9. A computer generated software product embodied within a storage medium for change detection of targets within regions of interest in a sensor derived data set comprising:
a server module operative to extract data fields from incoming data communications;
receiving a data set of sensor information collected in the field;
extracting features and regions of interest from within the sensor dataset;
constructing a classifier defined set of features;
building a separate data set containing identified and labeled targets;
generating a prioritization list of said identified and labeled targets;
presenting said prioritized list of identified and labeled targets to a human analyst; and
wherein the human analyst may input new labels and target identification to the prioritized list which is then incorporated into said data set containing identified and labeled targets, said data set then formatted and presented upon a display for use by the human analyst.

10. A method according to claim 9, wherein the sensors collecting data comprise an array of sensors deployed to collect samples from a defined area.

11. A method according to claim 9, further comprising:
said extraction of features and regions of interest is performed by a software module resident upon a server capable of network communications;
said software module comparing extracted features and regions of interest against a predefined set of interest criteria; and
wherein the server module provides a pre-screening function for all extracted data of interest.

12. A method according to claim 9, wherein said predefined interest criteria further comprise a defined set of features that form the basis data set of labels for all previously identified and selected targets.

13. A method according to claim 9, wherein the separate data set containing identified and labeled targets is separate from the basis data set of labels.

14. A method according to claim 9, wherein the separate data set containing identified and labeled targets includes labels generated by the server module without assistance from a human analyst.

15. A method according to claim 9, wherein said prioritized list is a combination of the basis data set of labeled targets and the separate data set containing labeled targets.

16. A method according to claim 9, wherein the human analyst provides feedback to the server module in a series of iterative steps that proceeds until all new data set information has been compared, identified, labeled, and/or discarded.
